(19) United States
(12) Patent Application Publication
(10) Pub. No.: US 2016/0019251 A1
(43) Pub. Date: Jan. 21, 2016

(54) System and Methods for Efficiently Storing Heterogeneous Data Records Having Low Cardinality

(71) Applicant: Lexmark International Technology, SA, Meyrin (CH)

(72) Inventors: Benjamin Andrew Marks, Kansas City, MO (US); Antonio Cabilao Saramosing, Olathe, KS (US); Kenneth Arba Lindsey, Pomona, KS (US); Wayne Andrew Rasmuss, Shawnee, KS (US)

(21) Appl. No.: 14/801,482

(22) Filed: Jul. 16, 2015

Related U.S. Application Data
(60) Provisional application No. 62/025,856, filed on Jul. 17, 2014.

(51) Int. Cl. G06F 17/30

(52) U.S. Cl. CPC G06F 17/30345; G06F 17/30339

(57) ABSTRACT

A method for organizing data records stored in a database having one or more row values and one or more row columns. The method includes determining at least one column from the one or more columns having high cardinality. A table is then created for the column having high cardinality, the created table including row values of the column having high cardinality. The method further includes determining a column having low cardinality and creating a second table for the column having low cardinality. The second table may include a descriptor of the column having low cardinality paired with a row value. The method may further include creating a third table that links the first and second tables.

### CROSS REFERENCE TO RELATED APPLICATIONS

Pursuant to 35 U.S.C. §119, this application claims the benefit of the earlier filing date of provisional application Ser. No. 62/025,856 filed Jul. 17, 2014 entitled “System and Methods for Efficiently Storing Heterogeneous Data Records having Low Cardinality,” the contents of which is hereby incorporated by reference herein in their entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to storing data records having low cardinality and, more particularly, storing heterogeneous data records having low cardinality in a database.

2. Description of the Related Art

Multiple devices in a network may generate data records which are processed and stored in one or more databases. When storing a large set of data with data fields on a database, it is typically a challenge to maintain a sustainable database storage size. Further, when each of the devices generates data records such as, for example, measurement data of varying types, the typical approach of modeling the measurement data is to store data for each distinct type of measurement in its own data store with columns and fields (e.g. rows) that match each specific type of measurement. For example, when storing different types of meteorological data, temperature data may be stored in a first data store, pressure data in a second data store, humidity data in a third data store, and so on. This approach may quickly become cumbersome because there may be several permutations of data fields for each type of measurement.

Another approach is to model the data as shown in FIG. 1 which shows an example denormalized database table 100 that stores data of varying type using columns 105A-105J and row values 110. For illustrative purposes, the table shown in FIG. 1 contains sample data from two different meteorological measurement setups: the first setup utilizes a mobile device that measures temperature and pressure and is capable of collecting GPS data such as, for example, data collected in rows 110a and 110b. The second example setup utilizes a stationary instrument that collects data for temperature, wind and humidity such as, for example, data collected in 110d and 110e. The first setup has one instrument that collects all data, while the second setup uses two instruments. In FIG. 1, multiple data records generated by the multiple meteorological instruments are clumped in one database table. The meteorological instruments may also be referred herein as data sources.

Using the example approach shown in FIG. 1, some fields such as, columns 105G-105J are set to accept null values for homogenous objects such as, for example, when datum is not available for that measurement or when the data sources are not capable of providing the values in the columns This example approach may be a workable solution in a simple data management case but as the number of data record types increases and as more data records are generated by the data sources, this solution may become difficult to work with. Further, if the data is stored in a relational database, or other rigidly structured data store, changes to the format will need to be made with each new record type generated. Each type of report may also need to be specifically implemented against the rigid data format.

Another approach that is typically used to solve the problem incurred in using the first approach discussed above is to adopt a key-value data store, or by implementing a data store in a relational database. FIGS. 2A-2D shows example relational database tables including Facts table 205 that is linked to Dimensions table 210. Data records in FIGS. 2A-2D correspond to data records shown in database table 100 of FIG. 1.

In FIG. 2A, column 215A contains identifiers for the row values that correspond to row values 210 of FIG. 1, while columns 215B and 215C corresponds to row 105B and 105C of FIG. 1. For illustrative purposes, the key-value data under Dimensions table 210 will be referred to herein as dimensions, and the measurement data records in Facts table 205 21. as facts. As shown, example Dimensions table 210 of FIGS. 2A-2D contains numerous repeated dimensions. In this illustrative embodiment, the dimensions are repeated for multiple records, and in other cases, subsets of the dimensions are repeated for each data record. It is worth noting that this would be the case even if another type of object or key value store is chosen over a relational store.

Accordingly, there is a need for a method of efficiently storing heterogeneous data records in a data set that minimizes repeated data in one or more data stores. There is a need to simplify database tables when the data records are heterogeneous and have low cardinality, to reduce storage use, and increase and maintain performance of queries.

### SUMMARY

Systems and methods for organizing data records stored in a database having one or more row values and one or more row columns are disclosed herein. In one example method for organizing data records, at least one column having high cardinality is determined from the one or more columns. A first table for the at least one column having high cardinality, the table including one or more row values of the at least one column determined to have high cardinality may then be created and at least one column having low cardinality is determined from the one or more columns A second table for the at least one column having low cardinality, the second table including a descriptor of the at least one column having low cardinality paired with a row value, may then be created. The method may also include a third table that links the first table and the second table.

In one aspect of the present disclosure, the third table may link the one or more row value of the first table to the corresponding one or more row values of the second table such that the one or more row values of the first table are each paired with the descriptor and the row value paired with the descriptor.

In another example embodiment of the present disclosure, a method of organizing data records in a database table having a plurality of columns and a plurality of row values for at least some of the columns is disclosed. The method includes determining a high cardinality column from the plurality of columns and creating a high cardinality table, the high cardinality table including the high cardinality column and its respective one or more row values. The method further includes determining one or more low cardinality columns from the plurality of columns; and creating a low cardinality table having a first column 31. including one or more descriptors of the determined one or more low cardinality columns, and a second column including one or more records under the determined one or more low cardinality columns. The method may also link a row from the high cardinality column to one or more rows in the low cardinality column using a new table.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, to and the manner of attaining them, will become more apparent and will be better understood by reference to the following description of example embodiments taken in conjunction with the accompanying drawings. Like reference numerals are used to indicate the same element throughout the specification.

FIG. 1 shows an example denormalized database table that stores data using columns and row values.

FIGS. 2A-2D shows example relational database tables including a Facts table that is linked to a Dimensions table.

FIG. 3 shows an example data processing environment for efficiently storing data records to minimize repeated values in a database table

FIG. 4 shows an example method of organizing data records to minimize data repeats.

FIG. 5 shows an example database that stores heterogeneous data records having low cardinality.

FIG. 6 shows extracted tables from the example tables of FIG. 5.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and to the scope of the present disclosure is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable medium that may direct a computer or other programmable data processing apparatus to function in a particular manner, such that the instructions stored in the computer-readable medium may produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also to be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods of efficiently storing heterogeneous data records having low cardinality. The heterogeneous data records may be stored efficiently by simplifying a denormalized table to reduce duplicate records in the database. Simplifying the table may include identifying high cardinality columns and grouping the data records under the high cardinality column in a table such as, for example, a facts table. Simplifying the table also includes identifying low cardinality columns and creating a key-value pair of the low cardinality columns and associating the key-value pairs with the corresponding high cardinality column data records in the facts table. The low cardinality columns may include dimensions and may comprise a table such as, for example, a dimensions table. Dimension subsets may be further identified and created to form a Dimension Subset table wherein each row value corresponds to multiple matching values (e.g. repeats) of the Dimension table, thereby reducing the duplicate values of the dimension table. The unique key-value pairs in the Dimension Subset table may then be associated with the data records of the Facts table through a join table that links each of the data record with the corresponding one or more dimension subsets. In one example embodiment, the join table may be a Dimension Set table that joins a Set ID from the Facts table with the corresponding subsets.

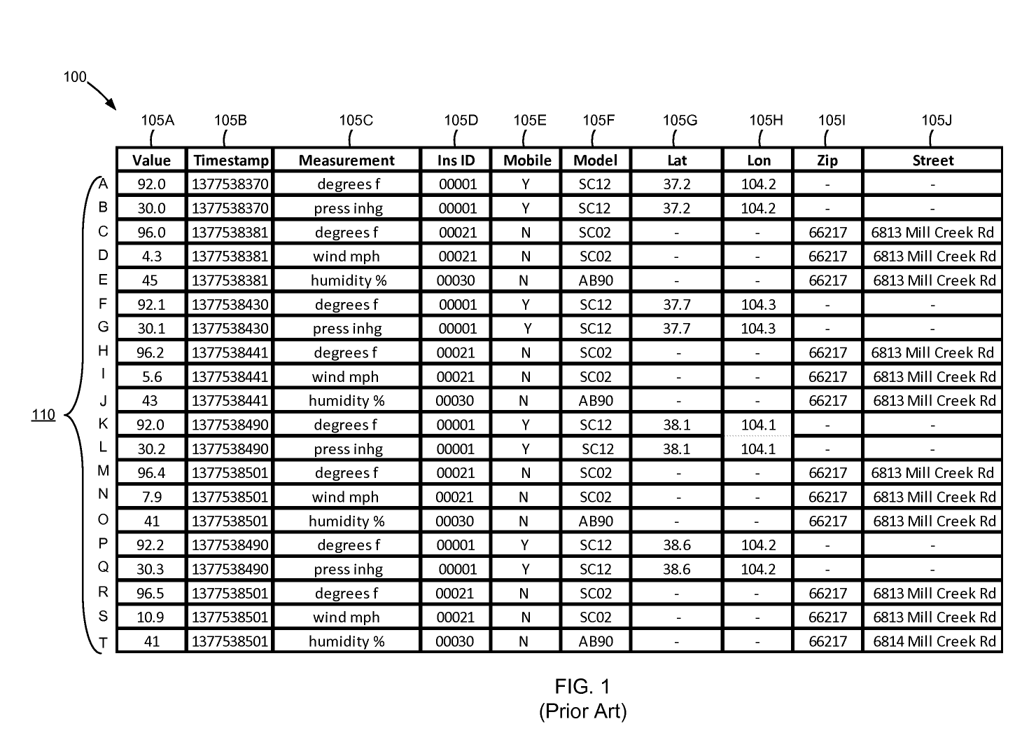

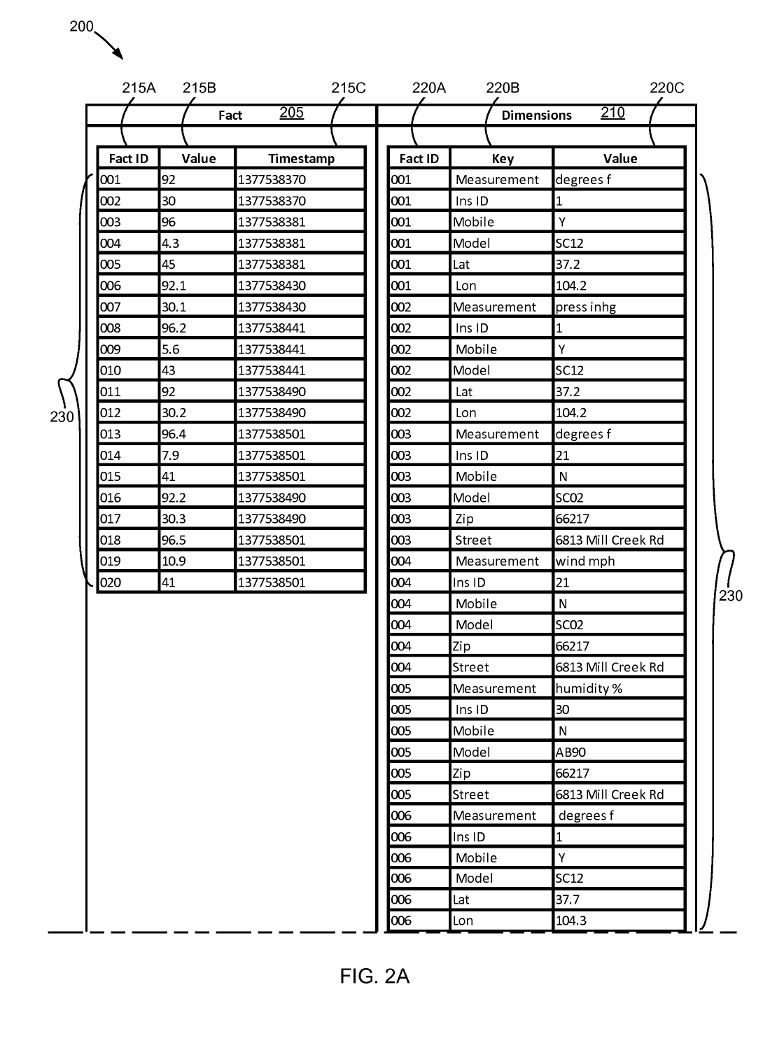

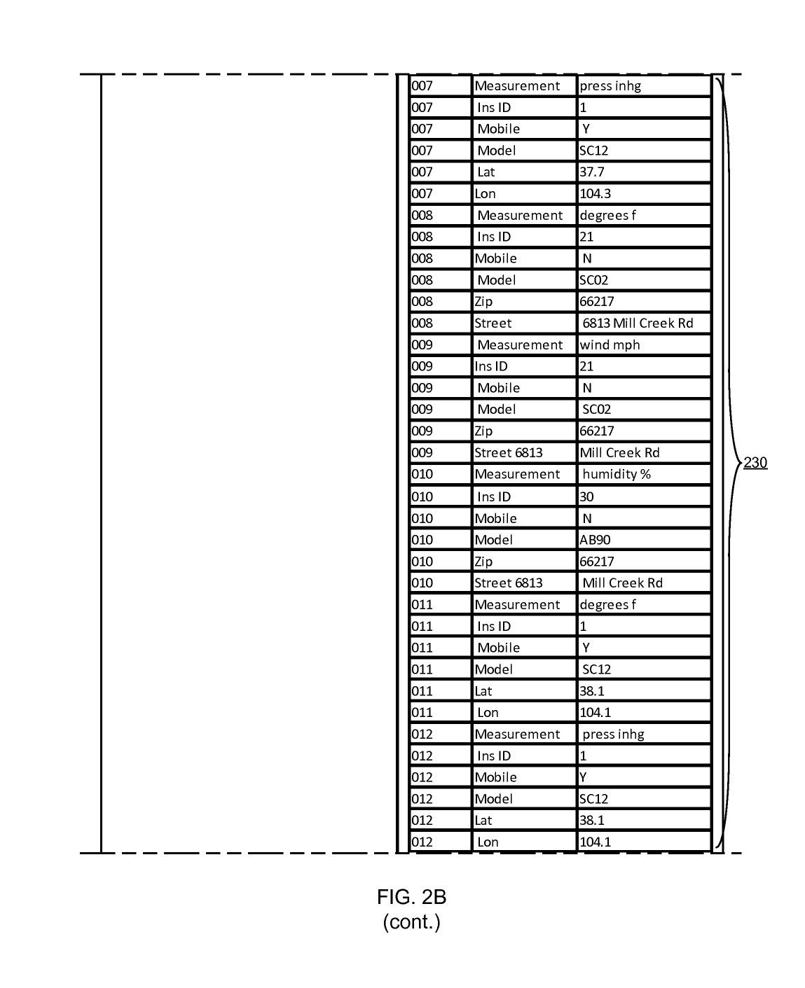

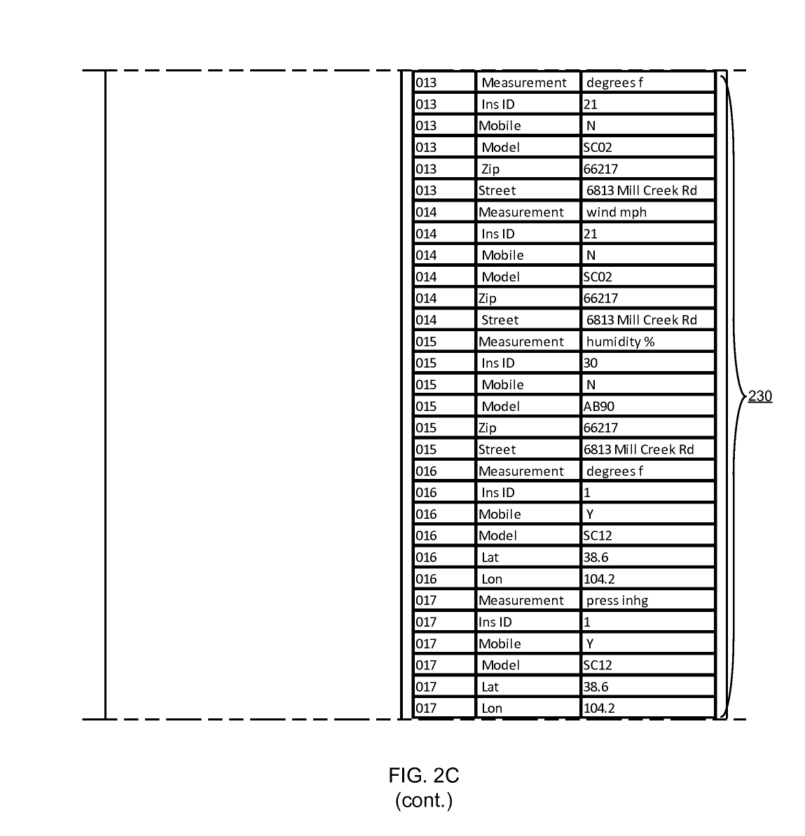

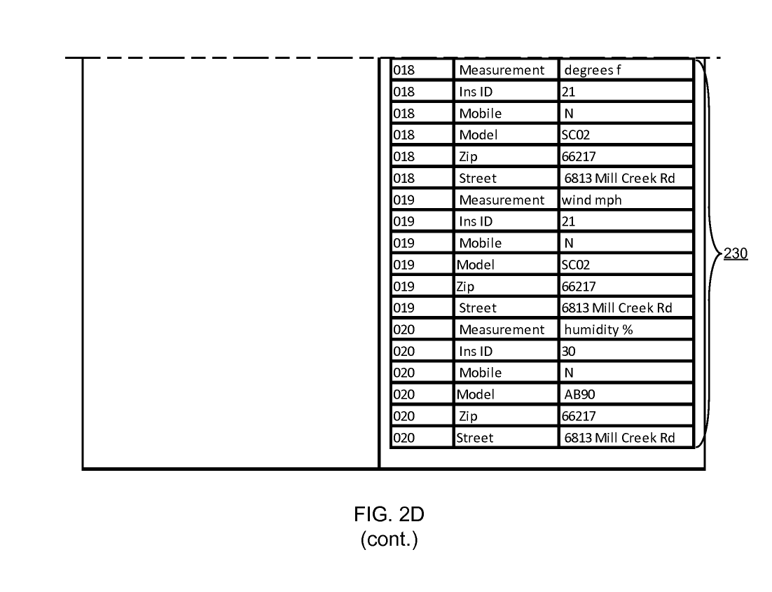

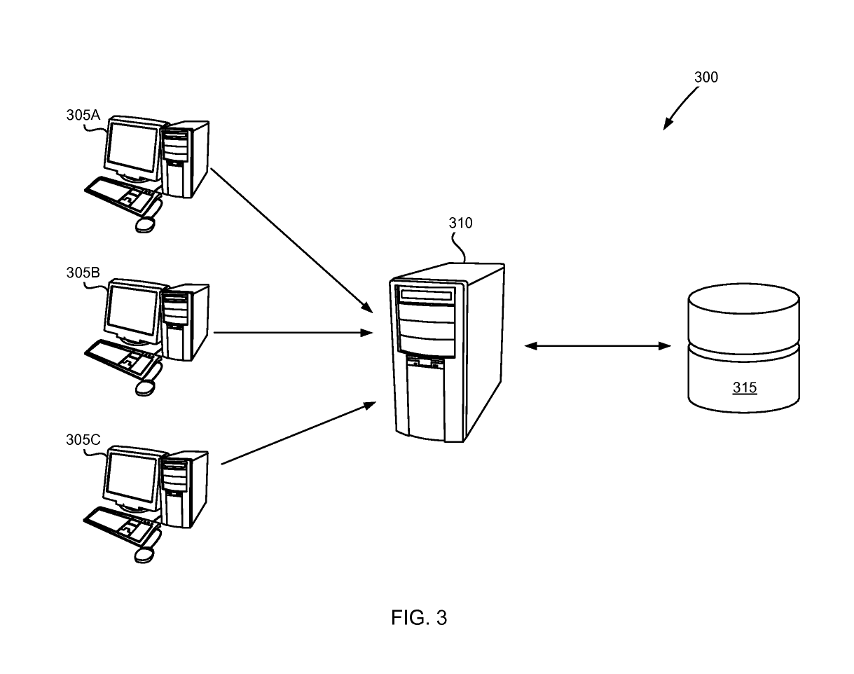

FIG. 3 shows an example data processing environment 100 for efficiently storing data records to minimize repeated values in a database table. Data processing environment 300 may include data sources 305, a server 310, and a repository 315 communicatively connected to each other through a network. Data sources 305 may be any device capable of generating data records. For illustrative purposes only, data sources 305 may be meteorological sensing equipment that collect temperature, humidity, wind, and pressure; and generate the measurement data shown in the data records of FIGS. 1 and 2A-2D.

Server 110 may be a computing device that receives data records generated by data sources and organizes the data records for storing in repository 115. Server 110 may be a typical computing device used by a data consumer for accessing the data records, or a specialized computing device for specific data management operations. In an alternative embodiment, server 110 may be part of a network of servers linked together to provide data storage and management services to users.

Repository 115 may be a database that stores data records generated by data sources 105 and organized by server 110. Repository 115 may be communicatively connected to server 105 in a network through one or more communication links that will be known in the art. Alternatively, repository 115 may be a database server that provides database services for data sources 105 in a client-server architecture. In an alternative example embodiment, server 110 may be a database server that performs the organization of data records received from data sources 105, and stores the data records to its database.

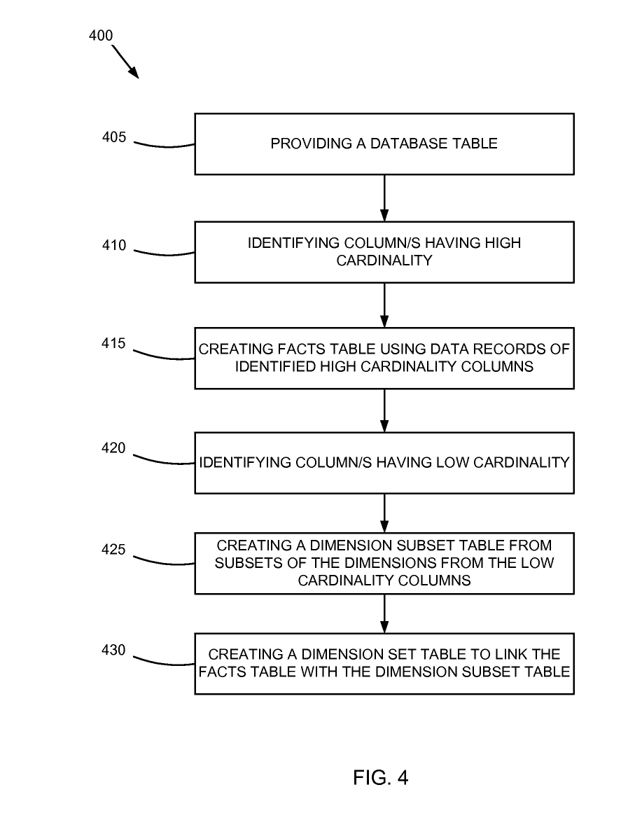

FIG. 4 shows an example method 400 of organizing and storing data records to minimize data repeats. The data records may be stored in a database such as, for example, a relational database. For illustrative purposes, the actions performed in method 400 utilizes the example database tables and data records of FIG. 1, FIGS. 2A-2D, and FIG. 4, using the example system 300 of FIG. 3.

At block 405, a database table 100 having columns 105A-105J and row values 110A-110T is provided. Table 100 is an example denormalized table wherein data records are stored without using a key-value data store. Repository 315 may receive each of the row values 110A-110T from data sources 305A-305C through server 310.

Columns 105A-105J may each be a set of data values of a particular type which provides the structure according to which the rows of table 100 are composed. For illustrative purposes, table 100 shows sample data from meteorological instruments that collects measurement values (e.g. Value 105A), a timestamp of the collection (Timestamp 105B), the measurement collected and the corresponding unit (Measurement 105C), instrument ID (Ins ID 105D), mobile capability of the instrument (Mobile 105E), model of the instrument (Model 105F), GPS coordinates (Lat and Lon columns 105G and 105H, respectively), and location of the instrument if stationary (Zip and Street columns 1051 and 105J, respectively). Each of row values 110A-110T represents a data record containing the values corresponding to columns 105A-105J.

As aforementioned, table 100 is a typical approach to storing data but this approach may become unwieldy as the more data records are generated by data sources 305A-305C and sent to repository 315 for storing.

At block 410, columns having high cardinality may be identified. In a context of a database, a column has high cardinality when it contains a large percentage of unique values. Identifying high cardinality columns may be performed automatically using a comparison between the number of occurrences (e.g. repeats) versus a predefined threshold. Alternatively, high cardinality columns may be manually identified by the database administrator even if the columns do not pass the criterion set for the specific cardinality.

In an example embodiment, a column is considered to have high cardinality when the number of repeats of its row values do not exceed a threshold which may be set by an authorized user of server 310 such as, for example, a database administrator. For example, Value column 105A may be considered a column having high cardinality since its row values are substantially unique or uncommon data values for the specific field. The values under column 105A occur not more than twice such as, for example, rows 110O and 110T both having the same value (e.g. 41), and rows 110A and 110K which share the value of 92.0. If the database administrator has set the high cardinality threshold criterion to be columns with row values not occurring more than four times, Timestamp column 105B may also be identified as a high cardinality column.

At block 415, a table may be created to include columns identified as having high cardinality. In reference to FIGS. 2A-2D, the table created may be Fact table 205 which includes example columns ID 215A, Value 215B, and Timestamp 215B. The example facts table may contain data corresponding to a metric, measurement or facts of a structured activity or task (e.g. meteorological measurement). ID 215A may be an identity column such as, for example, a primary key column that is used to uniquely define the values and/or characteristics of each row of Fact table 205. Columns 215B and 215C correspond to the Value and Timestamp 105A and 105B columns of table 100 of FIG. 1. The columns identified to be part of the fact table may be determined based on the high cardinality threshold criterion as explained above, or may be manually identified or defined to be a fact by the database administrator.

At block 420, columns having low cardinality may be identified. In a context of a database, a column has low cardinality when it contains a plurality of repeated values in its data range. Identifying low cardinality columns may be performed automatically by comparing the number of occurrences or repeats of a key-value pair versus a predefined threshold. Alternatively, low cardinality columns may be manually identified by the database administrator even if the columns do not pass the criterion set for the specific cardinality.

For example, low cardinality columns are columns having repeats that exceed a pre-defined threshold. For example, if the database administrator sets the threshold criterion for low cardinality columns to have values occurring more than four times, Measurement column 105C may be considered a low cardinality column since its row values (e.g. degrees f, and press inhg) occur more than four times. Using the example low cardinality threshold criterion, columns 105D-105J of FIG. 1 are also identified as low cardinality columns.

FIGS. 2A-2D shows an example table of dimensions linked to facts. Facts table 205 which includes data records identified to have high cardinality is linked to Dimensions table 210 through Fact ID 220A. Dimensions table 210 contains data corresponding to dimensions or identified low cardinality columns (e.g. Keys 220B), with the corresponding value for each of the low cardinality columns under Value 220C. Keys 220B and Value 220C form an example key-value pair that is linked to a data record in the Facts table 205 using Fact ID 220A. Fact ID 220A corresponds to the ID column in Facts table 205. It will be understood that Dimensions table 210 contains attributes that further describe the data records in Fact table 205.

However, as can be seen in FIGS. 2A-2D, Dimensions table 210 contains numerous repeated dimension subsets wherein one key-value pair, which will also be referred herein as a dimension subset, is repeatedly associated with multiple facts. For example, “Measurement” under Field value 220B has a corresponding value of “degrees f” that repeats eight times for the whole table. Dimension subset table 510 is created to include only one data record for the example multiple key-value pair: “Measurement” and “degrees f”.

At block 425, a dimension subset table may be created from one or more subsets from the dimensions that are repeatedly associated with facts. In the dimension subset table, each row value corresponds to multiple key-value pairs of the identified low cardinality columns, thereby eliminating the repeats of Dimensions table 210. A dimension set table may be created to link the dimension subset table with the facts table (at block 430).

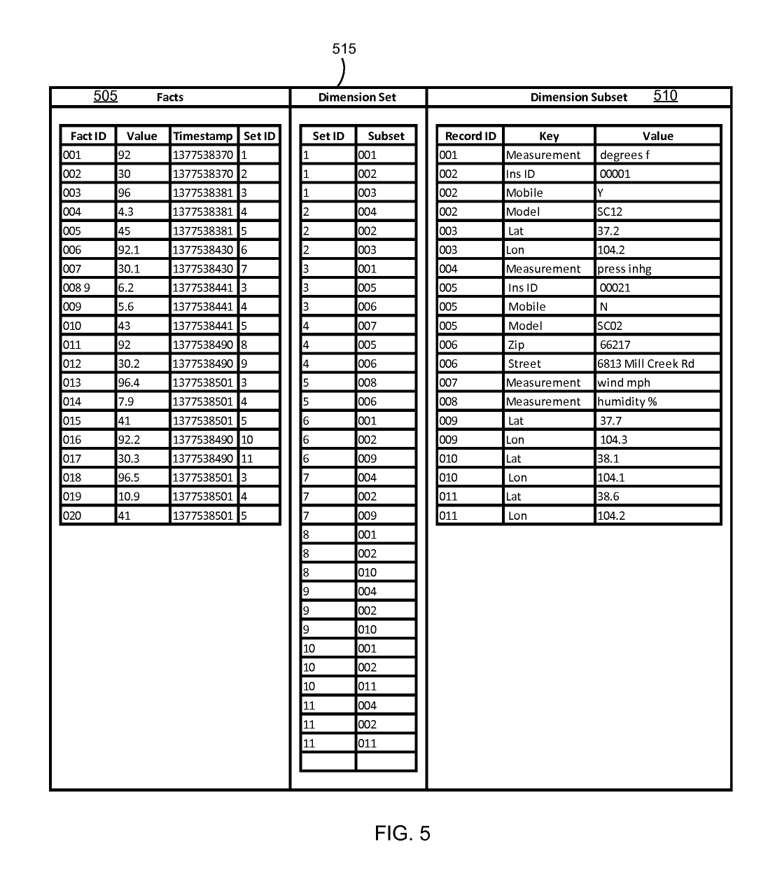

FIG. 5 shows an example database that efficiently stores heterogeneous data records having low cardinality. The example database is constructed by identifying to frequently-repeated subsets of dimensions and relating them to facts with a one-to-many relationship. For illustrative purpose, Facts table 505 is linked to subsets of the identified dimensions in Dimension Subset 510 using Dimension Set table 515. Dimension Subset table 510 is created to eliminate the repeats of Dimension table 210 by including an instance of the key-value pairs from Dimension table 210 and linking it to the Facts table 505 in a one-to-many relationship using Dimension Set table 515.

Identifying dimension subsets includes determining a set of one or more key-value pairs that are repeatedly associated with multiple facts. The identified dimension subsets are then associated with the corresponding facts using the Dimension Set table 510. Dimension Set table 510 joins Facts 515 with Dimension Subset 505 by linking Set ID 515A with Subset ID 515B.

For example, subset ID 001 having the key-value pair: “Measurement”=“degrees f” is associated with eight fact records having Fact IDs=0001, 003, 006, 008, 011, 013, 016 and 018. Instead of repeatedly associating Fact IDs 0001, 003, 006, 008, 011, 013, 016 and 018 with the key-value pair: “Measurement”=“degrees f”, the aforementioned Fact IDs are instead associated with a Set ID that is linked to corresponding Subset IDs to further associate the Fact IDs with their corresponding attributes without the use of duplicate row values.

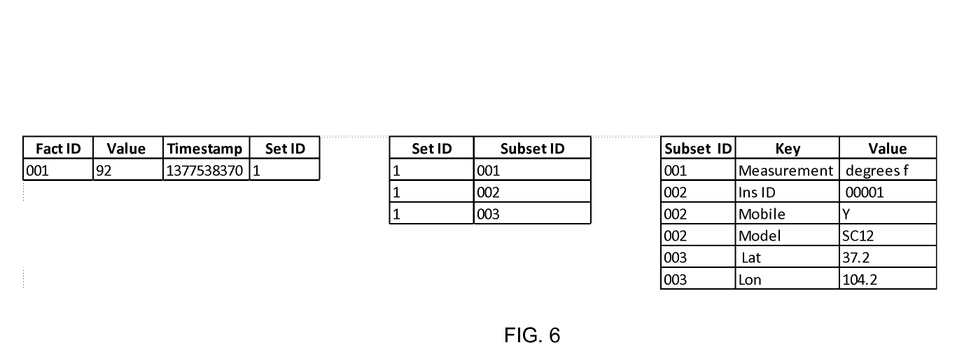

For illustrative purposes, FIG. 6 shows extracted tables from the example tables of FIG. 5. Fact ID=0001 is assigned to Set ID=001, which is further linked to Subset IDs =001, 002, and 003 under Dimension Set table 510. Using the link association specified under Dimension Set table 510, Fact ID=001 having Value=92 is therefore further associated with the following key-value pair attributes:

Measurement=degrees f (i.e. Subset ID=001),

Ins ID=0001, Mobile=Y, Model=SC12 (i.e. Subset ID=002), and

Lat=37.2 and Lon=104.2 (i.e. Subset ID=003).

The attributes associated with Fact ID=0001 using the example relational database of FIG. 5 correspond to the associated attributes as shown in 110A of FIG. 1, but with reduced number of repeats in the tables, thereby simplifying the database tables. Using the simplified table structures of FIG. 5 reduces storage use, and increases and maintains to performance of queries even with increasing number of data records generated by data sources 305A, 305B and 305C.

Method 400 may be performed by server 110 that reorganizes table 100 of FIG. 1 to form the example database 500 in FIG. 5 thereby simplifying the storing of data and minimizing use of data repeats in the database. In an alternative example embodiment, method 400 may be performed at a pre-defined schedule wherein the denormalized table (e.g. table 100) that is used to initially hold the data is provided and then reorganized using blocks 410-430 at a schedule set by the administrator. For example, reorganization of the data records from the denormalized table 100 to database 500 may be performed once every week, or once every two weeks.

In another example embodiment, the reorganization of the denormalized table may be performed when the denormalized table includes a pre-defined number of data records. For example, once the denormalized table contains 500 data records, method 400 may be performed to reorganized the data records and minimize repeats.

In another alternative example embodiment, if the example database of FIG. 5 has already been set, the table may further be organized using method 400 as newly generated data records are received by server 310 from data sources 305. When the server 310 receives a new data record from at least one of data sources 105, server may determine if the new data record contains high cardinality or low cardinality columns, and processes the data record using method 400 at blocks 410-430, accordingly. For example, server 310 may receive an example data record with the following values under the example columns set forth in table 100 of FIG. 1:

Value=93.0

Timestamp=1377538502

Measurement=degrees f

Ins ID=0021

Mobile=N

Model=SC02

Zip=66228

Street=6823 New Orchard Rd

Using the example steps of method 400, row values under Value and Timestamp columns are determined to be high cardinality since Value=93.0 and Timestamp=1377538502 are substantially unique and/or values do not repeat more than the predefined threshold such as, for example, four times. The new row values under the Value and Timestamp columns of the new data record are then added to the Facts table 505 as a new fact record having an example Fact ID=021.

The other columns of the new data record may be determined to belong low cardinality values since at least some of the values under Measurement, Ins ID, Mobile, Model, Zip and Street fields occur in the table more than the predetermined threshold such as, for example, four times.

It is then determined whether the new row values belong to an existing dimension subset from Dimension Subset Table 515. For this example, Measurement=degrees f corresponds to the Subset ID=1. Example new row values Ins ID=0021, Mobile=N, Model=SC02 also corresponds to an existing dimension Subset ID=005. Example new row values Zip=66228, Street=6823 New Orchard Rd have values that do not correspond to an existing dimension subset. Since Zip and Street columns have been determined to be low cardinality columns, a new dimension subset such as, for example, Subset ID=012 may be created to include the new row values Zip=66228, Street=6823 New Orchard Rd.

It will be appreciated that the actions described and shown in the example flowcharts may be carried out or performed in any suitable order. It will also be appreciated that not all of the actions described in FIG. 4 needs to be performed in accordance with the embodiments of the disclosure and/or additional actions may be performed in accordance with other embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for organizing data records stored in a database, the database having one or more row values and one or more row columns, the method comprising:
determining, from the one or more columns, at least one column having high cardinality;
creating a first table for the at least one column having high cardinality, the table including one or more row values of the at least one column determined to have high cardinality;
determining, from the one or more columns, at least one column having low cardinality;
to creating a second table for the at least one column having low cardinality, the second table including a descriptor of the at least one column having low cardinality paired with a row value; and
creating a third table that links the first table and the second table.

2. The method of claim 1, wherein the third table links the one or more row values of the first table to the corresponding one or more row values of the second table such that the one or more row values of the first table are each paired with the descriptor and the row value paired with the descriptor.

3. The method of claim 2, wherein the descriptor is a column name of the at least one column having low cardinality.

4. The method of claim 1, wherein the determining the at least one column having high cardinality includes identifying whether at least one value of the at least one column is repeated in a frequency that does not exceed a predefined high cardinality threshold.

5. The method of claim 1, wherein the at least one column having high cardinality is set by a user.

6. The method of claim 1, wherein the determining the at least one column having low cardinality includes identifying whether at least one value of the at least one column is repeated in a frequency that exceeds a predefined low cardinality threshold.

7. The method of claim 6, wherein the row value paired with the descriptor in the second table is representative of the at least one value repeated in a frequency more than the predefined low cardinality threshold.

8. The method of claim 1, wherein the at least one column having low cardinality are set by a user.

9. The method of claim 1, further comprising retrieving the data records from a database.

10. A method of organizing data records in a database table having a plurality of columns and a plurality of row values for at least some of the columns, comprising:
determining a high cardinality column from the plurality of columns;
creating a high cardinality table, the high cardinality table including the high cardinality column and its respective one or more row values;
determining one or more low cardinality columns from the plurality of columns;
creating a low cardinality table having a first column including one or more descriptors of the determined one or more low cardinality columns, and a second column including one or more records under the determined one or more low cardinality columns; and
linking a row from the high cardinality column to one or more rows in the low cardinality column.

11. The method of claim 10, wherein each of the one or more descriptors in the low cardinality table is paired with the one or more records based on determined one or more low cardinality columns from the plurality of columns.

12. The method of claim 10, wherein the low cardinality column is a column having at least one value repeated in a frequency more than a predetermined threshold.

13. The method of claim 10, wherein the high cardinality column is a column wherein each of the values does repeat more than a predetermined threshold.

14. The method of claim 10, wherein the high cardinality table further includes a column that references one or more rows in the set table.

15. The method of claim 14, wherein the set table further includes a first column that references a row in the high cardinality column, and a second column that references one or more rows in the low cardinality column.

16. The method of claim 15, wherein each row of the set table connects a row from the high cardinality table with another row from the low cardinality table using the first and second columns, respectively.

17. A computing device having non-transitory computer readable storage medium containing one or more instructions to:
determine at least one column having substantially unique records from a plurality of columns in a database table;
create a first table, the first table including the at least one column having substantially unique records;
determine at least one column having substantially duplicate records from the plurality of columns;
create a second table, the second table including a descriptor of each of the at least one column having substantially duplicate records and a record paired to the descriptor; and
create a third table, the third table linking each row of the first table to at least one row in the second table.

18. The computing device of claim 17, wherein substantially unique records are records not repeated in a frequency more than a predetermined threshold.

19. The computing device of claim 17, wherein the substantially duplicate records are records repeated in a frequency more than a predetermined threshold.

20. The computing device of claim 19, wherein the record paired to the descriptor in the second column is one instance of one of the substantially duplicate records.
